(19) United States
(12) Patent Application Publication
(10) Pub. No.: US 2005/0063550 A1
(43) Pub. Date: Mar. 24, 2005

(54) Sound image localization setting apparatus, method and program

(75) Inventor: Masami Koiwa, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: YAMAHA CORPORATION, Hamamatsu-shi (JP)

(21) Appl. No.: 10/943,422

(22) Filed: Sep. 17, 2004

(30) Foreign Application Priority Data
Sep. 22, 2003 (JP) 2003-330021

(51) Int. Cl. H04R 5/00; H04R 5/02

(52) U.S. Cl. 381/17; 381/310

(57) ABSTRACT

Movement pattern is generated which is indicative of a movement trajectory of a sound-image localized point, and the sound-image localized point is moved over time in accordance with the generated movement pattern. Thus, states set for various sound-image localized points can be automatically presented sequentially, without a user performing particular manual panning operation. By stopping the movement of the sound-image localized point at a desired point on the movement trajectory, the sound-image localized point on the movement trajectory when the movement has been stopped can be set as a sound image localization point. Audio signal, having been subjected to sound image localization control sequentially varied in accordance with the moved sound-image localized point, is audibly generated. Thus, the user listens to the generated audio and gives a movement stop instruction when he or she has auditorily felt that desired optimal sound image localization has been obtained, so that the localized point obtained at that time can be readily set as a sound image localization point.

### BACKGROUND OF THE INVENTION

The present invention relates to a sound image localization setting apparatus and method for setting sound image localization of audio signals, and a computer program for controlling the sound image localization. For example, the present invention is applied to an audio mixing apparatus or the like having a sound image localization setting function.

As well known, the audio mixing apparatus have a function for setting various types of parameters for an audio signal of each of a plurality of audio input channels, and among typical examples of such various types of parameters are sound image localizing (or panning) parameters. On the operation section (or console) of the conventionally-known audio mixing apparatus, there is provided, for each of a plurality of input channels, a rotary panning (or pan)-setting operator operable by a human operator or user to adjust sound image localization of an audio signal of that channel. The human operator can manually turn the rotary panning-setting operator of any input channel to be processed, to thereby set sound image localization of the audio signal, typically, in left and right stereo output channels.

In recent years, the overall system and mixing console of the mixing apparatus have been growing in scale or size along with advancements from the traditional sound field control in two-channel (i.e., left and right channel-) stereo systems to the multi-channel surround sound field control typified by the 5.1-channel surround system.

With the recent mixing apparatus having the increase scale or size of the overall system and mixing console, it has been cumbersome for human operators to find, from among various operators on the console, the panning-setting operator of a particular input channel for which sound image localization is to be adjusted and then perform desired operation while finding a desired sound image location. Further, the functions of the mixing apparatus, which are becoming more and more sophisticated and complicated, tend to present the inconvenience that the human operators sometimes can not appropriately perform operation for controlling sound image localization control while controlling other parameters, such as a tone volume and tone quality.

Further, in order to localize a sound image in the multi-channel surround system, there arises a need to adjust the sound image localization, e.g. in front-and-rear and left-and-right directions, and thus the localization adjusting operation tends to be cumbersome. In many cases, such localization adjustment in the front-and-rear and left-and-right directions is performed using a multi-dimensional operator, such as a joystick; however, in the case of the sound image localization using a joystick, it tends to be difficult for the human operator to confirm localization settings, which would unavoidably lead to poor operability. Further, because providing the multi-dimensional operator for each of the input channels is, in practice, almost impossible physically and economically, it has been conventional to use a single multi-dimensional operator to appropriately select a channel to be processed and then perform sound image localization adjustment for the selected channel. In this case, the human operator has to perform manual operation for selecting a desired one of an enormous number of input channels and sound image localization adjustment for each channel selected, which would result in inefficiency of sound image localization setting operation in the multi-channel surround system.

### SUMMARY OF THE INVENTION

In view of the foregoing, it is an object of the present invention to provide an improved sound image localization setting apparatus, method and program which allow sound image localization setting operation for audio signals to be performed with increased ease and efficiency.

In order to accomplish the above-mentioned object, the present invention provides a sound image localization setting apparatus for setting sound image localization for an audio signal processing apparatus which performs processing to localize a sound image of an audio signal, which comprises: a movement pattern generator that generates a movement pattern indicative of a movement trajectory of a sound-image localized point; a movement control section that moves the sound-image localized point over time in accordance with the movement pattern generated by the movement pattern generator; and a stop control section that stops movement, by the movement control section, of the sound-image localized point at a desired point on the movement trajectory. Here, the sound-image localized point on the movement trajectory when the movement of the sound-image localized point has been stopped by the stop control section is set as a sound image localization point.

According to the present invention, the sound-image localized point (sound image location) is moved over time in accordance with the generated movement pattern. Thus, states set for various sound-image localized points can be automatically presented sequentially, without the user or human operator performing particular manual panning operation. By stopping the movement of the sound-image localized point at any desired point on the movement trajectory, the sound-image localized point on the movement trajectory when the movement has been stopped can be set or ultimately determined as a sound image localization point. As a result, the present invention achieves the superior benefit of permitting sound image localization setting operation to be performed with enhanced simplicity and efficiency. Further, the present invention can eliminate a need for any mechanical sound image localization setting operator, which can thereby significantly simplify a console of the audio signal processing apparatus (i.e., mixing console). Needless to say, as an ordinary form of embodiment, each audio signal subjected to sound image localization is audibly generated or sounded via the audio signal processing apparatus (normally, mixing apparatus), so that the user can auditorily monitor an ever-changing sound image localization state. Therefore, while the sound-image localized point is being moved over time by the movement control section in accordance with the present invention, the audio signal processing apparatus audibly generates audio signal having been subjected to sound image localization control sequentially varied in accordance with the moved sound-image localized point. Thus, by test-listening to or auditorily checking the audio tone whose sound-image localized point is automatically moved in accordance with a given trajectory, the user or human operator can give an instruction for stopping the movement (movement stop instruction) once he or she has auditorily felt that desired optimal sound image localization has been obtained, so that the localized point obtained at that time can be readily set as a sound image localization point. As a result, the user only has to perform operation for instructing a stop of the movement in accordance with his or her feeling, which thus permits appropriate sound image localization setting to be performed with utmost ease.

The present invention may be constructed and implemented not only as the apparatus invention as discussed above but also as a method invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing an example hardware setup of a mixing apparatus in accordance with an embodiment of the present invention;

FIG. 2 is a plan view extractively showing important portions of a mixing console employed in the embodiment of FIG. 1;

FIG. 3 is a functional block diagram explanatory of an outline of a feeling pan function in the embodiment of FIG. 1;

FIGS. 4A and 4B are plan views showing examples of sound image localization movement patterns associated with the feeling pan function in the embodiment;

FIG. 5 is a flow chart of a main program routine performed in the embodiment of the mixing apparatus; and

FIGS. 6A and 6B are a flow chart of feeling pan processing performed in the embodiment of the mixing apparatus.

### DETAILED DESCRIPTION OF THE EMBODIMENTS

Mixing apparatus of the present invention, which is an audio signal processing apparatus for performing processing to localize sound images of audio signals, will be described hereinbelow, assuming that it is capable of sound field control in a multi-channel surround system (e.g., 5.1-channel surround system).

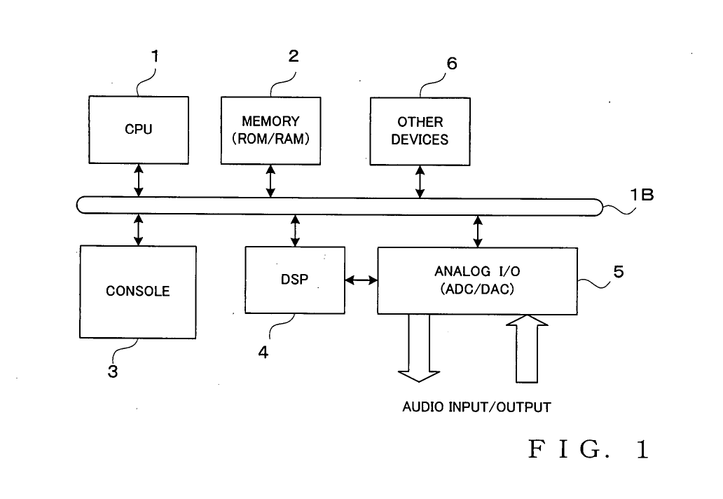

FIG. 1 is a block diagram showing an example hardware setup of a digital audio mixing apparatus in accordance with an embodiment of the present invention, which generally comprises a CPU 1, a memory section 2 including a ROM and RAM, a mixing console 3, a signal processing circuit (DSP) 4, an analog input/output interface (analog I/O) 5 and other devices 6. These components (devices) are interconnected via a communication bus 1B. The CPU 1 executes various programs, stored in the memory section 2, to control behavior or operation of the entire mixing apparatus. As well known, the mixing apparatus has a function for setting various parameters, such as a tone volume and sound image localization (panning), for an audio signal of each of a plurality of channels. The mixing console 3 includes various operators operable by a user or human operator to set various mixing-related parameters etc., and a display device capable of visually displaying settings (or set states) of the various parameters. The human operator can input various instructions and various parameter setting values to the mixing apparatus via the mixing console 3. Details of the mixing console 3 will be described later.

The analog I/O 5, which is an interface for inputting and outputting audio signals to and from the mixing apparatus, includes an A/D converter for converting each analog audio signal, to be input to the mixing apparatus from the outside, to digital representation and a D/A converter for converting each digital signal, to be output from the mixing apparatus to the outside, into analog representation. The mixing apparatus has a predetermined plurality of input channels and a predetermined plurality of output channels. Audio signal is input via the analog I/O 5 to the mixing apparatus separately for each of the predetermined plurality of input channels, and then distributed to the predetermined plurality of output channels to be output from the mixing apparatus.

Digital audio signals converted via the analog I/O 5 are supplied to the DSP 4. On the basis of control signals and parameter setting signals generated by the CPU 1, the DSP 4 performs a process for setting various parameters for the digital signals and a mixing process on the digital signals. Results of the processes are output via the analog I/O 5 after having been converted into analog audio signals. The parameter setting signals supplied from the CPU 1 to the DSP 4 are signals for, for example, setting sound image localization etc., on the basis of which the DSP sets a sound image localization setting value for a desired input channel, selected as an object of processing (i.e., “to-be-processed channel”), and thereby performs a sound image localization process on the audio signal (digital signal) of the desired input channel. Fundamentals of the sound image localization process by the DSP 4 will not be described in detail because the process itself is well known in the art. Generally, sound image localization of an audio signal is achieved by controlling a tone volume difference (power balance) between a plurality of corresponding audio output channels and tone generating time difference between the corresponding audio output channels (e.g., tone generating timing between left and right speakers).

The mixing apparatus of FIG. 1 has, as the sound image localization setting function to be performed by the CPU 4, a function which, in determining sound image localization of an audio signal for each of the channels, can automatically move a sound image location (or sound-image localized point) of the audio signal along a predetermined movement trajectory (or movement pattern) and set, as a sound image localization setting value of the audio signal, a given sound-image localized point when the human operator judges or felt that appropriate sound image localization has been obtained. Such a sound image localization setting function based on automatic movement of the sound-image localized point will be called in this disclosure “feeling pan function” to distinguish from the conventional sound image localization setting function based on manual operation.

Let it be assumed that, in the illustrated embodiment, audio signals output from the mixing apparatus are audibly generated or sounded via a sound system (not shown). Namely, the human operator can operate the mixing apparatus while test-listening to, and hence auditorily checking, audio signals having been subjected to the setting of various parameters, such as sound image localization setting parameters, and the mixing process. The following description assumes, as a listening environment of the human operator, a multi-channel surround system where two-dimensional sound image localization setting is to be performed; however, the listening environment may be other than the multi-channel surround system, such as two (i.e., left and right)-channel stereo sound system.

Further, in the illustrated example of FIG. 1, the other devices 6 include an external storage device, such as a hard disk device, a network interface for connection to a communication network, a computer interface for connection to another external device, such as a personal computer, etc. The CPU 1 can execute control programs etc. not only stored in the ROM and the like of the memory section 2, hard disk and external storage medium, such as a CD-ROM, but also downloaded from outside the apparatus via the communication network.

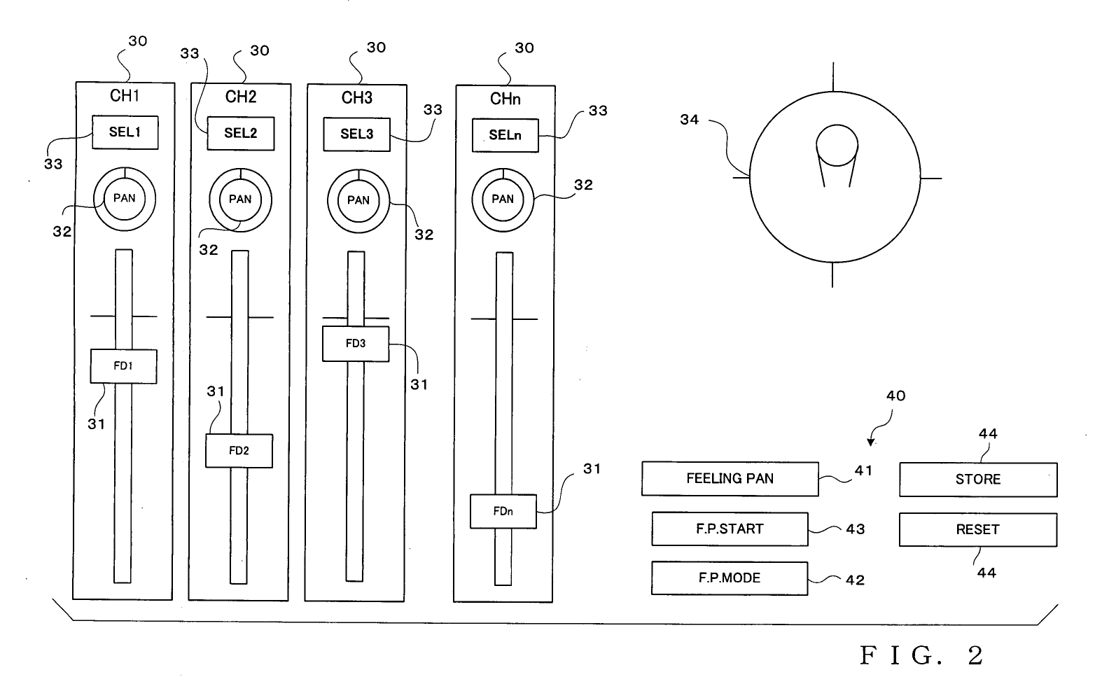

FIG. 2 is a plan view extractively showing important portions of the console 3. As illustrated in FIG. 2, the console 3 includes a plurality of (i.e., n) channel slits (CH1-CHn) 30 corresponding to the plurality of (i.e., n) audio signal input channels, and a group of switches 40 that pertain to the sound image localization process of the present invention.

Each of the channel slits (CH1-CHn) 30 includes a fader-type operator (FD1-FDn), a dial-type panning setting operator 32, and a select switch (SEL1-SELn) 33. The human operator can operate the various operators of each of the channel slits 30 to thereby manually set various parameters etc. for the audio signal of that channel.

On each of the channel slits (CH1-CHn) 30, the fader-type operator 31 is an operator for controlling the tone volume level of the audio signal of the channel, and is slidingly operable by the human operator in the up-and-down direction. The dial-type panning setting operator 32 is an operator for manually adjusting panning between left and right stereo output channels for the audio signal of the channel, and is rotationally operable in the left-and-right (counterclockwise/clockwise) direction.

The select switch 33 is an operator for selecting a channel on which the “feeling pan function” is to be performed, which is implemented by a push-button switch. The human operator can select any desired one of the channels CH1-CHn as a to-be-processed channel by turning on the select switch 33 of the channel. Note that the select switches 33 are just an example of channel selection means and the present invention may employ other suitable channel selection means than these select switches 33. For example, in a case where the fader-type operator 31 of each of the channels is in the form of a fader provided with a touch sensor, arrangements may be made to allow the human operator to select a to-be-processed channel by only touching the fader-type operator of the channel. Alternatively, a to-be-processed channel may be selected on a GUI display where settings of the individual channels can be managed in a collective or centralized manner.

Further, reference numeral 34 illustrates a joystick (two-dimensional operator) for manually setting two-dimensional sound image localization in the front-and-rear and left-and-right directions, and, in the illustrated example, only one such joy stick is provided on the console 3. Selection, by the joystick, of a channel to be subjected to sound image localization setting may be made, for example, on the GUI display, or via the above-mentioned select switch 33. It will be understood from the following description that, in the present invention, the two-dimensional sound image localization setting can be performed easily and efficiently without use of the joystick 34, in other words, more or less sensorily.

The group of switches 40 includes a feeling pan switch (“FEELING PAN”) 41, feeling pan mode switch (“F.P. MODE”) 42, feeling pan start switch (“F.P. START”) 43, store switch (“STORE”) 44, and a reset switch (“RESET”) 45. Let it be assumed that the above-mentioned switches 41-44 in the illustrated embodiment are each in the form of a push button switch.

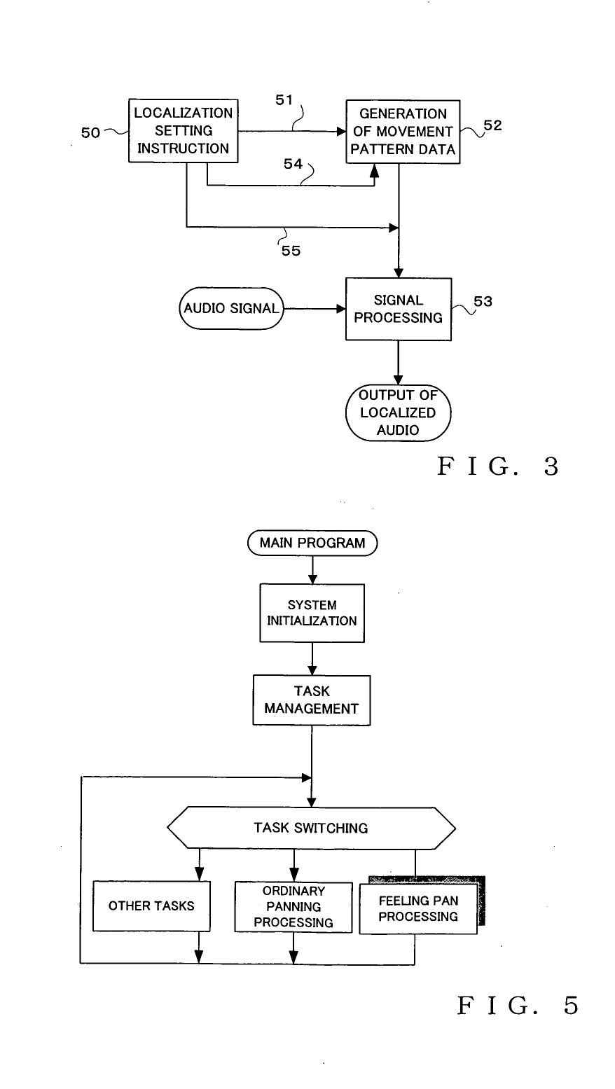

The feeling pan switch 41 is a switch for switching the operation mode of the mixing apparatus to the “feeling pan” function. The feeling pan function is turned on or off each time the feeling pan switch 41 is operated by the human operator. FIG. 3 is a functional block diagram explanatory of an outline of the feeling pan function. In FIG. 3, block 50 indicates that the human operator has instructed execution of sound image localization setting based on the feeling pan function, i.e. that the feeling pan function has been turned on. After turning ON of the feeling pan function, the human operator selects or designate a channel for which sound image location is to be adjusted.

The feeling pan mode switch 42 (FIG. 2) is a switch for performing various setting related to an execution environment of the feeling pan function. The various setting related to the execution environment of the feeling pan function includes selection of a sound image location movement pattern, setting of a movement speed, ON/OFF setting of a function for temporarily stopping the sound image location movement at predetermined specific points on a movement trajectory. Let it be assumed that one setting menu can be changed over to another each time the human operator depresses the feeling pan mode switch 42. Contents of these setting menus are displayed on the display device provided on the console 3 so that any desired menu and menu item can be selected and set on the GUI display.

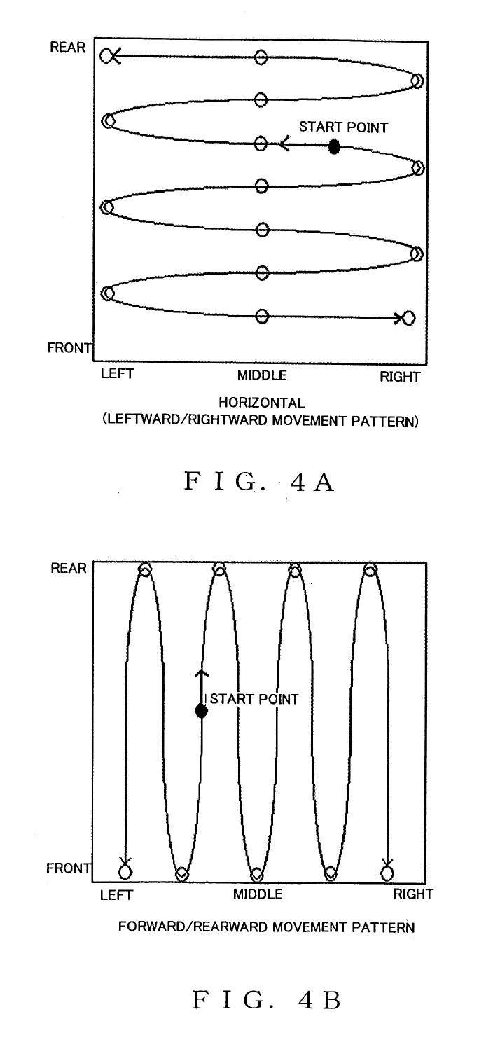

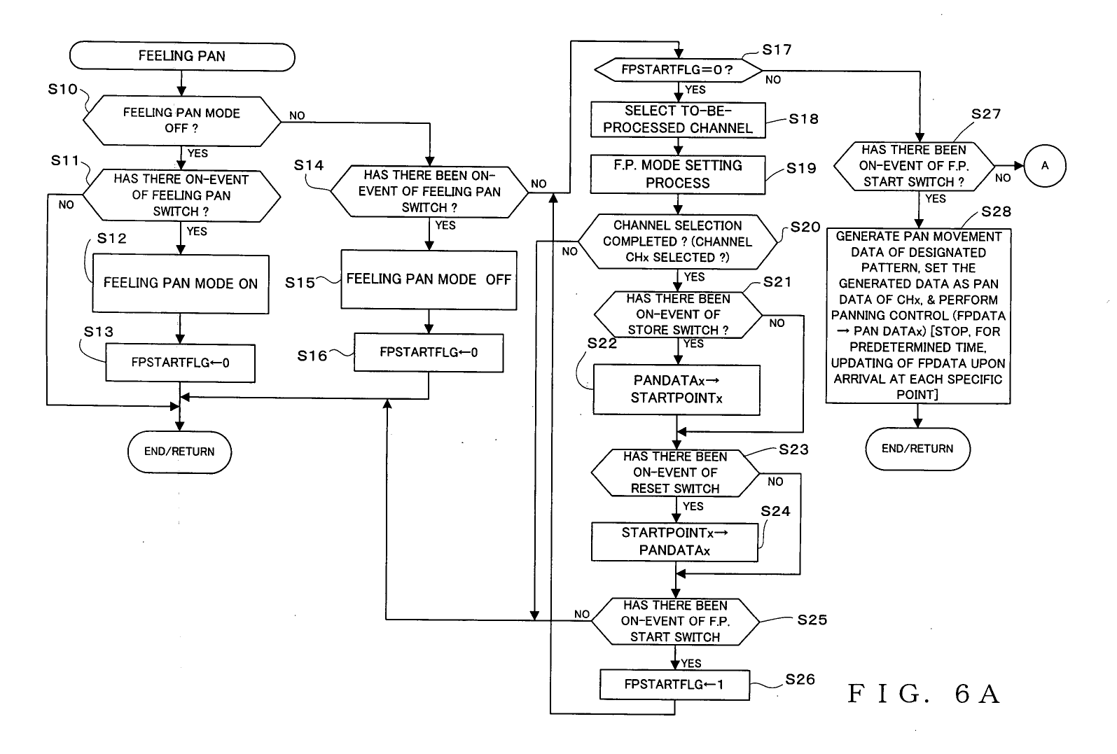

Specific examples of the sound image location movement pattern are described with reference to FIGS. 4A and 4B, of which FIG. 4A illustrates a horizontal movement pattern while FIG. 4B illustrates a front-and-rear movement pattern. In FIGS. 4A and 4B, a rectangular frame schematically represents a sound field space (listening environment). Further, an upward direction of the figures represents a rearward direction of the sound image location movement in the sound field space, a downward direction of the figures represents a forward direction of the sound image location movement, leftward/rightward direction of the figures represents a leftward/rightward direction of the sound image location movement. The human operator can select any desired one of a plurality of sound image location movement patterns including those shown in FIG. 4. The sound image location movement may be of any desired patterns without being limited to the two patterns illustrated in FIGS. 4A and 5B, such as a spiral pattern. Basically, there may be employed a sound image location movement pattern or trajectory curved as if to scan every nook and cranny of the sound field space (or sound field plane); however, even a simple sound image location movement pattern, in accordance with which the localized position is linearly reciprocated in the leftward/rightward direction or forward/rearward direction, may be used without causing any inconvenience in practicing the present invention. Further, in the instant embodiment, there may be used sound image location movement patterns prestored in the ROM or RAM of the memory section 2, or other suitable storage means, as well as other desired sound image location movement patterns created by detecting and recording actual movement, by the human operator, of a mouse or other pointing device or input via a tablet (or digitizer). The mixing apparatus may further be equipped with these pattern input functions. Also, sound image location movement patterns may be automatically created in response to input of appropriate parameters, rather than in response to user's operation. Further, there may be created a plurality of sound image location movement patterns so that the user can select any desired one of the created patterns.

Further, in FIGS. 4A and 4B, sound-image localized points represented by small while circles are specific points, such as left, right, front and rear end points and middle points on the movement trajectory. By temporarily stopping the sound image location (or sound-image localized point) movement at such specific points, the human operator, test-listening to or auditorily checking an audio tone whose sound-image localized point is being automatically moved, is allowed to reliably recognize that the moving sound-image localized point has been positioned at the specific points. This arrangement can achieve an advantage similar to that achieved through ordinary operation of the panning setting operator 32 or the like where, for example, each middle point of leftward/rightward panning movement is differentiated using an eye mark that serves to enhance a visibility of the middle point as a predetermined operational reference position (see FIG. 2) or using a click (catch) feeling during rotational operation of the panning setting operator 32 or the like. Note that the means for clarifying the specific points may be other than the above-described, such as a visual display or alarm illuminated or sounded each time the specific point is reached.

The feeling pan start switch 43 is an operator for initiating the sound image location movement by the feeling pan function of the present invention. While the switch 43 is being depressed by the human operator, it is kept ON so that the automatic sound image location movement process is performed. Once the feeling pan start switch 43 is released by the human operator, it is turned off, so that ending or stop of the sound image location movement is instructed. Namely, when the feeling pan start switch 43 is depressed when the mixing apparatus is in the “feeling pan” mode (as indicated by arrow 51 of FIG. 3), the CPU 1 generates data (i.e., movement pattern data) for causing the sound-image localized point along a predetermined trajectory (block 52 of FIG.

3). The movement pattern data are intended to variably set a sound image localization setting value of the DSP 4 such that the sound-image localized point is varied over time to draw a predetermined trajectory as illustrated, for example, in FIG. 4A or 4B. Note that the movement pattern data can be generated, for example, by reference to a predetermined data table or arithmetic operation of a predetermined function varying over time.

The DSP 4 localizes an audio signal to be processed, on the basis of the localization setting value. Because the localization setting value is varied over time on the basis of the generated movement pattern data, the sound-image localized point of the audio signal is moved automatically. The sound image location movement is initiated with an initial localization setting value, set in the DSP 4 when the feeling pan start switch 43, used as a movement start point (“signal processing” of block 53). Thus, each audio having been localized through the signal processing is output, so that the human operator can listen to the audio whose localized position is automatically moved. When the human operator has judged that optimal localization has been obtained while listening the audio with its localized position moving along a predetermined trajectory, the human operator turns off the feeling pan start switch 43 in order to set the localization, namely, generation of the movement pattern data is terminated (flow indicated by arrow 54 of FIG. 3).

The store switch 44 of FIG. 22 is operable by the human operator to store the sound image location, moved by the feeling pan function (i.e., current localization setting value of the CPU 4), as a sound image location of the channel in question. Namely, the current localization setting value of the CPU 4 is stored, for example, in the RAM of the memory section 2, as a localization reference point parameter (also referred to as “start point data”) of the channel in question. Namely, the human operator uses the store switch 44 to determine, as the sound image localization setting of the audio signal of the channel, the localization setting value obtained when the sound image location movement has been stopped (flow indicated by arrow 55 of FIG. 3). In the above-described manner, the feeling pan function allows the human operator to determine an optimal sound image location while test-listening to an audio tone whose sound-image localized point is automatically moved, which is therefore very useful in user's sound image localization setting operation while auditorily checking the sound-image localized audio tone and which can also enhance the sound image localization setting efficiency. In addition, the human operator is allowed to perform the sound image localization setting operation in a sensory manner.

Further, in FIG. 2, the reset switch 45 is an operator operable by the human operator to reset the localization setting value, currently set in the DSP 4, to the setting value stored as the start point data of the channel in question. This switch 45 is used, for example, when the localization setting value of the DSP 4 is to be reset to the value stored as the start point data of the channel, e.g. after the sound-image localized point has been moved by the feeling pan function, to thereby return to a home position. Let it be assumed here that a given localization reference point parameter (start point) is preset as an origin point for each of the channels. Namely, even where overwriting of the start point data by the store switch 44 is not executed, some origin point, to which the localization setting value is to be returned, is set and stored per channel.

FIG. 5 is a flow chart of a main program routine executed in the mixing apparatus of the present invention. Upon powering-on of the apparatus, the CPU 1 performs a “system initialization process” and then a “task management process” on various tasks to be executed by the mixing apparatus, so that the mixing apparatus is placed in a state ready to execute a task responsive to input operation by the user (“task switching”). Namely, in response to operation, by the human operator, of any of the operators on the console 3, a process corresponding to the operator operation, and then processes following the “task switching” process is performed in a repeated fashion. Here, a “normal panning process” is a manual panning process performed using the panning setting operator 32 or joy stick 34. In response to turning-on, by the human operator, of the feeling pan switch 41 (FIG. 2), “feeling pan processing” is initiated.

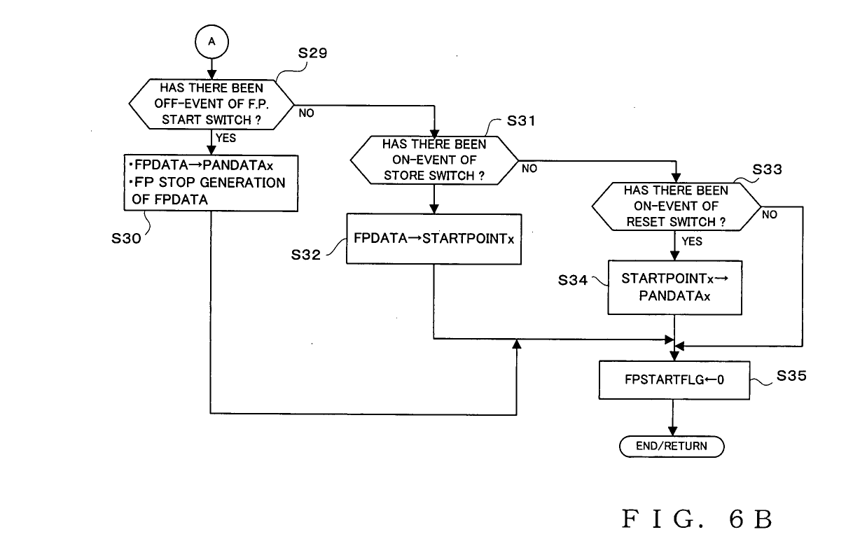

FIG. 6 is a flow chart showing an example operational flow in the feeling pan processing. Although the flow of FIG. 6 is shown as divided into FIGS. 6A and 6B for convenience of illustration, the flow shows a series of operational steps connected at a connection point A.

At step S10, a determination is made as to whether the mixing apparatus is now performing the feeling pan function, by determining whether or not a “feeling pan mode” is currently OFF. With a YES determination at step S10, i.e., if the mixing apparatus is currently not in the feeling pan mode, the CPU 1 detects an operational event of the feeling pan switch 41, at step S11. If an ON event of the feeling pan switch 11 has been detected (YES determination at step S11), it means that the human operator has instructed turning-on of the feeling pan function, so that the CPU 1 proceeds to step S12 in order to turn on the feeling pan function or feeling pan mode. Then, at step S13, a feeling pan start flag is reset to “0” (FPSTARTFLG=0). The feeling pan start flag can take one of two states or values, “FPSTARTFLG=1” and “FPSTARTFLG=0”, to distinguish between a start and end of the feeling pan processing. Specifically, “FPSTARTFLG=0” indicates an end of the feeling pan processing, while “FPSTARTFLG=1” indicates a start of the feeling pan processing.

If, on the other hand, a negative (NO) determination is made at step S10, i.e. the feeling pan mode has already been turned on, the CPU 1 goes to step S14 in order to detect an operational event of the feeling pan switch 41. If ON operation of the feeling pan switch 41 has not been performed by the human operator (NO determination at step S14), the CPU 1 proceeds to step S17 in order to carry on with the feeling pan processing. If there has been an ON event of the switch 41 as determined at step S14, the feeling pan function is turned off at step S15. Then, the feeling pan start flag is reset at step S13.

With the above-described operations, the feeling pan function is turned on/off via the feeling pan switch 41 in a “toggle-like” manner.

At step S17, it is determined whether the feeling pan flag is currently at the value “0”. Immediately after the feeling pan function has been initiated, the feeling pan start flag is in the reset (“0”) state (through operation at step S13), the CPU 1 goes to step S18, where it selects a to-be-processed channel to be subjected to sound image localization setting by the feeling pan function. In the illustrated embodiment, the human operator selects a channel via the select switch 33 (FIG. 2) provided on the channel strip of the channel. Further, at step S19, the CPU 1 receives various settings made via the feeling pan mode switch 42 (FIG. 2) Here, the human operator determines various conditions related to sound image location movement including selection of a sound image location movement pattern, selection of a sound image moving speed, ON/OFF setting of the temporary stop function at specific points on the sound image location movement trajectory.

At step S20, the CPU 1 ascertains that the channel selection operation has been completed and hence the to-be-processed channel has been determined. In subsequent operations, the thus-selected channel (hereinafter represented by “CHx”) is treated as an object of the sound image localization by the feeling pan function. In the illustrated example, if no to-be-processed channel has been selected (NO determination at step S20), the CPU 1 reverts to step S10 in order to repeat the operations at and after step S10 until a to-be-processed channel is selected by the human operator.

If any to-be-processed channel has been selected (YES determination at step S20), the CPU 1 proceeds to step S21, where an operational event of the store switch 44 is detected. If an ON event of the store switch 44 has been detected, the current localization setting value of the DSP 4 (i.e., localization data PANDATAx) is stored as the start point data (STARTPOINTx) of the channel in question. After that, the CPU 1 proceeds to step S23, where an operational event of the reset switch 45 is detected. If an ON event of the reset switch 45 has been detected, the value stored as the start point data (STARTPOINTx) of the channel is sent to the DSP 4 and set as the localization data (PANDATAx). Namely, when the reset switch 45 has been turned on, the current localization setting value of the DSP 4 (i.e., localization data) is reset to a value stored as the start point data (STARTPOINTx) of the channel CHx in question.

At step S25, an operational event of the feeling pan start switch 43 is detected. If an ON event of the switch 43 has been detected (YES determination at step S25), the CPU 1 goes to step S26, where the feeling pan start flag is set to “1” (FPSTARTFLG=1) so that the automatic sound image location (i.e., sound-image localized point) movement is now ready to be started.

If, on the other hand, no ON event of the switch 43 has been detected (NO determination at step S25), the CPU 1 reverts to step S10 in order to repeat the operations at and after step S10 until the feeling pan start switch 43 is turned on by the human operator.

After the feeling pan start flag has been set to “1” at step S26, the CPU reverts to step S17, where a NO determination is made this time. Namely, it is confirmed, by the feeling pan start flag at the value “1”, that the automatic sound image location movement is now ready to be started. At next step S27, a determination is made as to whether the feeling pan start switch 43 is currently in the ON state. Because, as noted earlier, the feeling pan start switch 43 is kept ON while the switch 43 is being depressed by the human operator and turned off once the human operator releases the switch 43, that the start switch 43 is currently in the ON state means that the human operator is now keeping on depressing the switch 43. If the feeling pan start switch 43 is currently in the ON state (YES determination at step S27), the CPU 1 moves on to step S28.

At step S28, the CPU 1 generates movement pattern data (FPDATA) corresponding to the sound image location movement pattern designated by the human operator at step S19 above, and sends the thus-generated movement pattern data (FPDATA) to the DSP 4. The DSP 4 sets the received movement pattern data (FPDATA) as the localization data (PANDATAx) of the current to-be-processed channel CHx and performs a sound image localization (panning control) process on the audio signal of the channel CHx using the localization data as a localization setting value.

In the illustrated flow, the feeling pan processing returns after the DSP 4 has performed the panning control, and as long as the human operator keeps depressing the feeling pan start switch 43 (FIG. 3), a NO determination is made at each of steps S10, S14 and S17 and the operations leading to up step S28 are carried out repeatedly. During that time, the movement pattern data generated by the CPU 1 is sequentially updated, so that the localization data (PANDATAx) set in the DSP 4 is sequentially varied. Timing at which the data is updated is set in accordance with the moving speed designated at step S19. Namely, during depression of the feeling pan start switch 43, updating of the localization data (PANDATAx) is continued, so that the sound-image localized point represented by the localization data (PANDATAx) of the channel CHx is sequentially moved, leaving a trajectory represented by the movement pattern data.

If the setting has been made, at step S19, to temporarily stop the sound image location at each specific point on the sound image location movement trajectory, the updating of the movement pattern data (FPDATA) is ceased for a predetermined time at step S28 each time the sound-image localized point represented by the localization data reaches a specific point, such as a front, rear, left, right or middle point; thus, the sound image location movement can be temporarily stopped at each of the specific points.

Once the feeling pan start switch 43 is turned off by the human operator releasing the switch 43, a NO determination is made at step S27, and then the CPU 1 goes to step S29 of FIG. 6B. At step S29, presence/absence of an OFF event of the feeling pan start switch 43 is detected. If an OFF event of the switch 43 has been detected, the CPU 1 moves on to step S30, where generation of the movement pattern data (FPDATA) is ceased and the current movement pattern data (FPDATA) is set in the DSP 4 as localization data (PANDATAx) of the channel CHx. Then, at step S35, the feeling pan start flag is reset to “0”, and the feeling pan processing returns. In this way, the automatic sound image location movement is temporarily stopped. Once the human operator again depresses the feeling pan start switch 43, the sound image location movement is resumed with the localization data, currently set in the DSP 4, used as start point data.

By proceeding to step S31 and other steps succeeding step S31 after the NO determination at step S29, the CPU 1 can detect presence/absence of an operational event of the store switch 44 or reset switch 45 during the OFF state of the feeling pan start switch 43. If the store switch 44 has been turned on (YES determination at step S31), the current movement pattern data (FPDATA) is stored as start point data of the channel CHx, at step S32. If the reset switch 45 has been turned on (YES determination at step S33), the localization data currently set in the DSP 4 (i.e., sound-image localized point when the movement was ceased) is reset to the start point data (STARTPOINTx) of the channel CHx, at step S34. At following step S35, the feeling pan start flag is reset to “0” (FPSTARTFLG=0).

Because the feeling pan start flag is reset to “0” (FPSTARTFLG=0) at step S35, a YES determination is made at step S17 when the processing returns after step S35 and a NO determination is made at each of steps S10 and S14, as long as the feeling pan function is ON. Thus, at step S18, the CPU 1 can accept a change of the channel to be subjected to the sound image localization setting. If a new channel has been selected as the to-be-processed channel, the feeling pan processing is performed on the new to-be-processed channel in a manner to the above-discussed, so that the sound image localization can be set for the new to-be-processed channel through the automatic sound-image localized point movement. Even when no new channel selection operation is performed at step S18, step S20 makes a YES determination that “channel selection has been made”, as long as any one of the channels (CHx) is currently in the selected state. Thus, each of steps S21 and S23 detects presence/absence of an operational event of the store switch 44 or reset switch 45, to thereby perform operations for overwriting with the localization data currently set in the DSP 4 as start point data, resetting the last movement stop point, etc.

In the above-described operation of repeating step S28, the sequentially-updated localization data (PANDATAx) may be not only sequentially set in the DSP 4 but also temporarily stored, as localization data, in the RAM or the like of the memory section 2.

Further, the mixing apparatus of the present invention may have a function for collectively storing in memory the localization data updated in all of the channels. Such a collectively storing function can be implemented by arranging the apparatus in such a manner that the localization data of all the channels can be stored in response to simultaneous depression of a predetermined key (e.g., shift key) and the store switch 44.

The above-described embodiment is arranged to allow the human operator or user to make various settings and give various instructions related to the feeling pan function via the switch group 40, such various settings and various instructions may be made or given via a GUI capable of centralized control of the mixing apparatus. Furthermore, a personal computer may be connected to the mixing apparatus to allow the personal computer to make various settings and give various instructions, such as the channel selection. Moreover, the connected personal computer may be constructed to perform a feeling pan function similar to the above-described.

Whereas the preferred embodiment has been described above in relation to the case where the present invention is applied to a mixing apparatus, the present invention may be applied to other similar apparatus than the mixing apparatus, such as those having an audio signal processing function. Further, the present invention may also be arranged and implemented as a computer program for controlling such apparatus.

Furthermore, the described embodiment is arranged to perform sound-image localized point movement in accordance with a movement pattern while the feeling pan start switch 43 is in the ON state and stop the localized point movement when the switch 43 is turned off; however, the localized point movement may be instructed in any other suitable manner. For example, switching may be made between the start and stop of the localized point in a toggle-like fashion each time the feeling pan start switch 43 is turned on.

Furthermore, in the case where the sound-image localized point is automatically moved, a plurality of movement patterns may be used in a sequentially-switched manner, instead of only one movement pattern being used. For example, in case a favorite sound-image localized point can not be found with a first movement pattern, the first movement pattern may be automatically switched over to another movement pattern upon completion of the first movement pattern. In this case, the switching order, in which switching is made between plurality of movement patterns, and the types of the movement pattern may be selected as desired by the user, or fixed previously, or varied in a random fashion.

1. A sound image localization setting apparatus for setting sound image localization for an audio signal processing apparatus which performs processing to localize a sound image of an audio signal, said sound image localization setting apparatus comprising:
a movement pattern generator that generates a movement pattern indicative of a movement trajectory of a sound-image localized point;
a movement control section that moves the sound-image localized point over time in accordance with the movement pattern generated by said movement pattern generator; and
a stop control section that stops movement, by said movement control section, of the sound-image localized point at a desired point on the movement trajectory,
wherein the sound-image localized point on the movement trajectory when the movement of the sound-image localized point has been stopped by said stop control section is set as a sound image localization point.

2. A sound image localization setting apparatus as claimed in claim 1 wherein said stop control section stops the movement of the sound-image localized point when a predetermined instruction for stopping the movement has been given by a user.

3. A sound image localization setting apparatus as claimed in claim 1 wherein at least one of a start of the movement of the sound-image localized point by said movement control section and a stop of the movement of the sound-image localized point by said stop control section is instructed in response to operation of a predetermined operator by a user.

4. A sound image localization setting apparatus as claimed in claim 1 wherein, while the sound-image localized point is moved over time by said movement control section, said audio signal processing apparatus audibly generates an audio signal having been subjected to sound image localization control sequentially varied in accordance with the moved sound-image localized point.

5. A sound image localization setting apparatus as claimed in claim 1 wherein said movement pattern generator generates a movement pattern indicative of a movement trajectory curved as if to scan a sound field.

6. A sound image localization setting apparatus as claimed in claim 1 wherein said movement pattern generator generates a movement pattern selected from among a plurality of movement patterns.

7. A sound image localization setting apparatus as claimed in claim 1 which further comprises a pattern creation section that creates a given movement pattern, and wherein said movement pattern generator generates the movement pattern created by said pattern creation section.

8. A sound image localization setting apparatus as claimed in claim 7 wherein said pattern creation section creates a given movement pattern in response to operation, by a user, of a predetermined operator.

9. A sound image localization setting apparatus as claimed in claim 7 wherein said pattern creation section creates a plurality of given movement patterns, and said movement pattern generator generates a movement pattern selected from among the plurality of movement patterns created by said pattern creation section.

10. A sound image localization setting apparatus as claimed in claim 1 wherein said movement control section is capable of setting or selecting a speed at which the sound-image localized point should be moved in accordance with the movement pattern.

11. A sound image localization setting apparatus as claimed in claim 1 wherein said movement control section temporarily stops movement of the sound-image localized point once a predetermined specific point on the movement trajectory is reached during a period when said movement control section moves the sound-image localized point over time in accordance with the movement pattern.

12. A sound image localization setting apparatus as claimed in claim 11 wherein the predetermined specific point is a position on the movement trajectory corresponding to a substantial middle position of a sound field, or an end position of the sound field where a direction of the movement trajectory reverses.

13. A sound image localization setting apparatus as claimed in claim 1 which further comprises an announcement section that announces, by a visual display or alarm sound, that a predetermined specific point on the movement trajectory is reached during a period when said movement control section moves the sound-image localized point over time in accordance with the movement pattern.

14. A program containing a group of instructions for causing a processor to perform sound image localization setting processing for setting sound image localization for an audio signal processing apparatus which performs processing to localize a sound image of an audio signal, said sound image localization setting processing comprising:
a step of supplying a movement pattern indicative of a movement trajectory of a sound-image localized point;
a step of moving the sound-image localized point over time in accordance with the movement pattern supplied by said step of supplying; and
a step of receiving an instruction for stopping movement, by said step of moving, of the sound-image localized point at a desired point on the movement trajectory,
wherein the sound-image localized point on the movement trajectory when the movement of the sound-image localized point has been stopped is set as a sound image localization point.

15. A sound image localization setting method for setting sound image localization for an audio signal processing apparatus which performs processing to localize a sound image of an audio signal, said sound image localization setting method comprising:
a step of supplying a movement pattern indicative of a movement trajectory of a sound-image localized point;
a step of moving the sound-image localized point over time in accordance with the movement pattern supplied by said step of supplying; and
a step of receiving an instruction for stopping movement, by said step of moving, of the sound-image localized point at a desired point on the movement trajectory,
wherein the sound-image localized point on the movement trajectory when the movement of the sound-image localized point has been stopped is set as a sound image localization point.
